(19) United States
(12) Patent Application Publication
(10) Pub. No.: US 2002/0129326 A1
(43) Pub. Date: Sep. 12, 2002

(54) Method for inserting repeaters in hierarchical chip design

(76) Inventors: Paul D. Nuber, Ft. Collins, CO (US); Christopher J. Arnold, Fort Collins, CO (US)

Correspondence Address: AGILENT TECHNOLOGIES, INC., Legal Department, 51U-PD, Intellectual Property Administration, P.O. Box 58043, Santa Clara, CA, 95052-8043, US

(21) Appl. No.: 09/802,214

(22) Filed: Mar. 8, 2001

(51) Int. Cl. G06F 17/50

(52) U.S. Cl. 716/12

(57) ABSTRACT

A novel method for inserting interconnect repeaters in integrated circuits according to the functional block hierarchy of the chip design is presented. Routing and repeater insertion is performed on blocks on a first level of the functional block hierarchy. Routing and repeater insertion is then performed on blocks on a next level of the functional block hierarchy. The process repeats recursively until all functional block levels are processed.

### FIELD OF THE INVENTION

The present invention pertains generally to interconnect routing in integrated circuits, and more particularly to a recursive method for inserting interconnect repeater, in integrated circuits according to the functional block hierarchy of the integrated circuit design.

### BACKGROUND OF THE INVENTION

Integrated circuits comprise a plurality of electronic components that function together to implement a higher-level function. ICs are formed by layering multiple layers of metal materials, interleaved between a dielectric material, over a silicon wafer. The fabrication process entails the development of a schematic diagram that defines the circuits to be implemented. A chip layout is generated from the schematic. The chip layout, also referred to as the artwork, comprises a set of planar geometric shapes over several layers that implement the circuitry defined by the schematic. A mask is then generated for each layer based on the chip layout. Each mask is then successively layered over the silicon wafer according to the layer's associated mask using a photolithographical technique.

The process of converting the specifications of an electrical circuit schematic into the layout is called the physical design process. CAD tools are extensively used during all stages of the physical design process. The physical design process is accomplished in several stages including partitioning, floorplanning, and routing.

During the partitioning stage, the overall integrated circuit is partitioned into a set of functional subcircuits called blocks (and herein referred to as “functional blocks”). The block partitioning process considers many factors including the number and size of the blocks, and the number of interconnections between the blocks. The output of partitioning is a set of functional blocks along with a set of interconnections required between blocks, referred to herein as a “netlist”.

During the floorplanning stage, a floorplan is developed defining the placement and shape, and placement of interconnect ports, of each functional block. It is a goal in the floorplanning stage to select the optimal layout for each functional block, as well as for the entire chip.

Once an acceptable floorplan is developed, the interconnections between the blocks (as defined by the netlist) are routed. The space not occupied by the blocks is partitioned into rectangular routing channel regions. Interconnects are preferably routed within the designated channels, but may also be routed through defined feedthroughs through the blocks, or in defined over-the-block routing space. The goal of a router is to complete all circuit connections resulting in minimal interconnect signal delay. Interconnects are routed over one or more horizontal and vertical layers. Often, interconnect routes resulting from the autorouting will be too long to meet signal delay specifications. The delay results from the inherent RC characteristics of the interconnect line. Signal transition time can often be significantly improved by introducing one or more signal repeaters along the path of the interconnect line.

Conventional routing methods, e.g., mid-1990's, operated on a flat model of the chip, routing without regard to the functional block hierarchies. This can be problematic because it often results in iterative changes to the block interfaces. More recent algorithms, such as that implemented in Aristo Technology's “IC Wizard”, understand two levels of block hierarchy. However, these algorithms place all repeaters at the lower level, and result in modification of the block interfaces to do so. Accordingly, a need exists for a method for inserting repeaters in an integrated circuit design according to the functional block hierarchy in order to preserve functional block interfaces.

### SUMMARY OF THE INVENTION

The present invention is a novel method and system for inserting interconnect repeaters in integrated circuits according to the functional block hierarchy of the chip design. In accordance with the invention, repeaters are inserted in an integrated circuit according to the functional block hierarchy of the chip design. First, port locations are assigned for each of the blocks. An unrouted block in an unprocessed hierarchical functional block level is routed and then repeaters are inserted in the block to generate a processed block. Another unprocessed block in the current functional block hierarchy is selected, routed, and repeaters are inserted therein. The routing and repeater insertion process is continued until all blocks in the same hierarchical functional block level are processed. The process is then repeated on another unprocessed level of the functional block hierarchy. This process repeats recursively until all functional block levels are processed.

In a preferred embodiment, if the selected block comprises a port connecting the selected block to an as-yet unprocessed block in a higher functional block level, a nearest-port distance between the port and its nearest repeater in the selected block is calculated. When the parent block is later processed, this nearest-port distance is used in the repeater location calculations to ensure that the total length of the wire between the nearest repeater or electronic component port in the child block and the nearest repeater or electronic component port in the parent block conforms to repeater location parameters (e.g., maximum wire length of X microns).

The invention therefore allows optimal repeater insertion in functional blocks while preserving the functional block interfaces.

### BRIEF DESCRIPTION OF THE DRAWING

The invention will be better understood from a reading of the following detailed description taken in conjunction with the drawing in which like reference designators are used to designate like elements, and in which:

FIG. 1 is a top view of an integrated circuit floorplan that has been flattened in order to see all the levels in the block hierarchy;

FIG. 2 is a diagram illustrating the level of each block in the block hierarchy of the design example of FIG. 1;

FIG. 3 is an operational flowchart illustrating a novel method in accordance with the invention for inserting repeaters in integrated circuits according to the functional block hierarchy;

FIG. 4 is a block diagram of an illustrative embodiment of a CAD tool environment in which the method of the invention is implemented;

FIG. 5 is a flowchart of a preferred embodiment method of the invention for inserting repeaters; and

FIG. 6A is a floorplan view of a block at a first level of the functional block hierarchy of FIGS. 1 and 2 with repeaters inserted in accordance with the invention;

FIG. 6B is a floorplan view of a block at a second level of the functional block hierarchy of FIGS. 1 and 2 with repeaters inserted in accordance with the invention; and

FIG. 6C is a floorplan view of a block at a third level of the functional block hierarchy of FIGS. 1 and 2 with repeaters inserted in accordance with the invention.

### DETAILED DESCRIPTION

A novel method and system for inserting interconnect repeaters in integrated circuits while preserving block-level interface definitions is described in detail hereinafter. Although the invention is described in terms of specific illustrative embodiments, such as specifically identified CAD tools, it is to be understood that scope of the invention is not limited thereby.

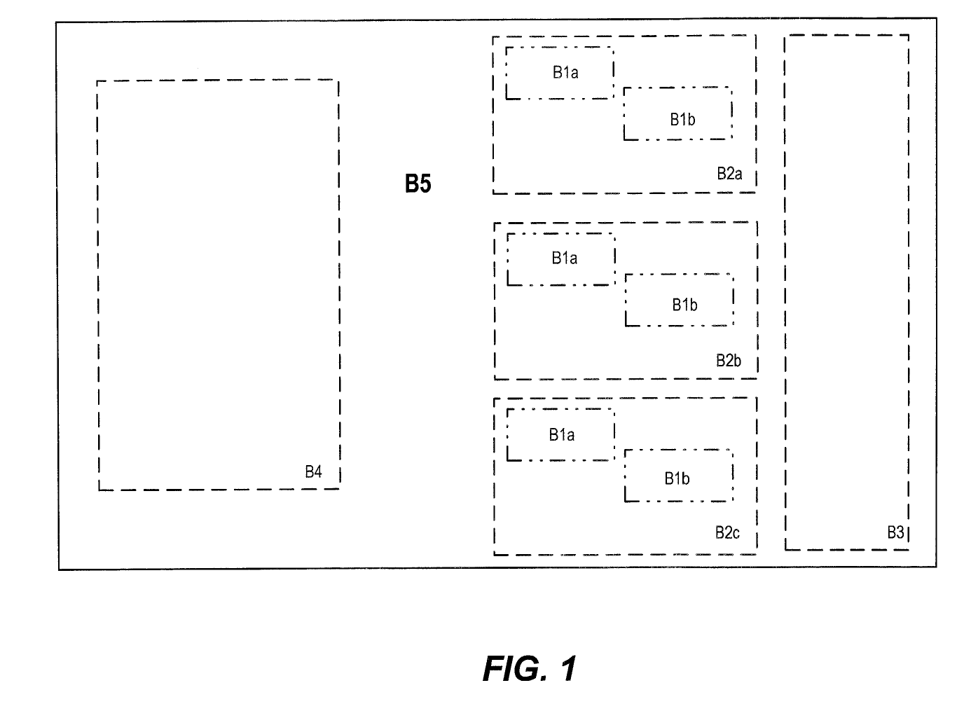

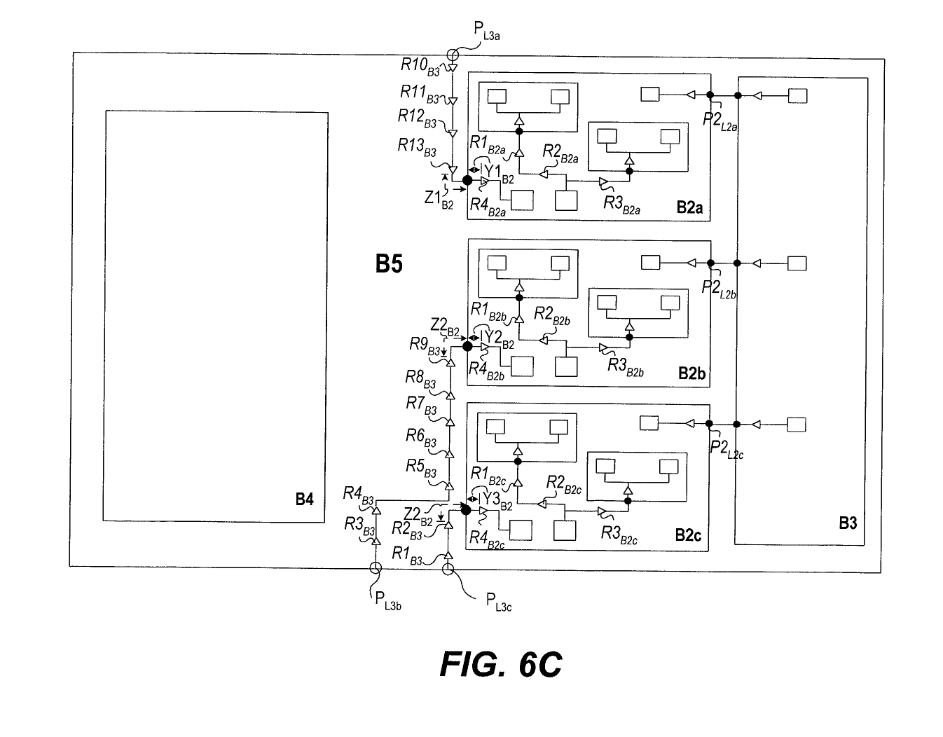

FIG. 1 is a top view of an integrated circuit floorplan that has been flattened in order to see all the levels in the block hierarchy. The floorplan view illustrates the placement of functional blocks implemented therein. Routing channels and bypass capacitors typically fill the space in between the blocks; however, for ease of understanding of the invention, they are not shown. In the illustrative embodiment, the integrated circuit, shown as block B5 comprises multiple functional blocks B2a, B2b, B2c, B3, and B4. Blocks B2a, B2b, and B2c are each identical instances of the same block B2 (FIG. 6B, discussed hereinafter). Each instance B2a, B2b, and B2c comprises functional blocks B1a and B1b. Blocks B1a and B1b are each identical instances of the same block B1 (FIG. 6A, discussed hereinafter).

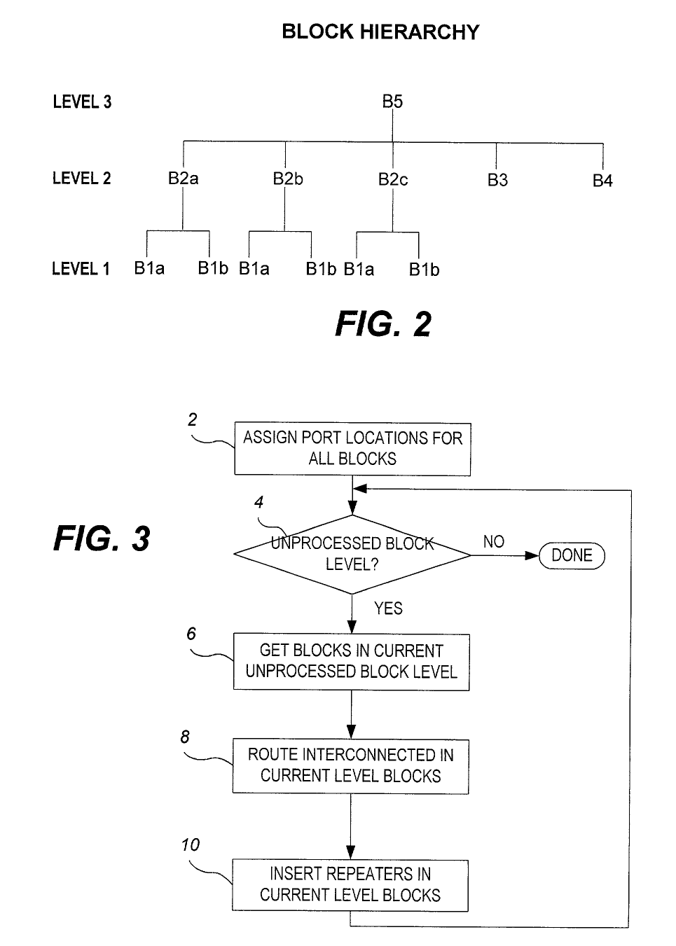

FIG. 2 is a block hierarchy diagram illustrating the level of each block in the functional block hierarchy. The hierarchy level of each functional block is also illustrated in FIG. 1 using differing line patterns. According to FIGS. 1 and 2, Level 1 blocks B1a and B1b are child blocks of each of Level 2 functional blocks B2a, B2b, and B2c. Blocks B2a, B2b, and B2c are also parent blocks of blocks B1a and B1b. Level 2 functional blocks B2a, B2b, B2c, B3 and B4 are child blocks of Level 3 functional block B5. Block B5 is a parent block of blocks B2a, B2b, B2c, B3 and B4.

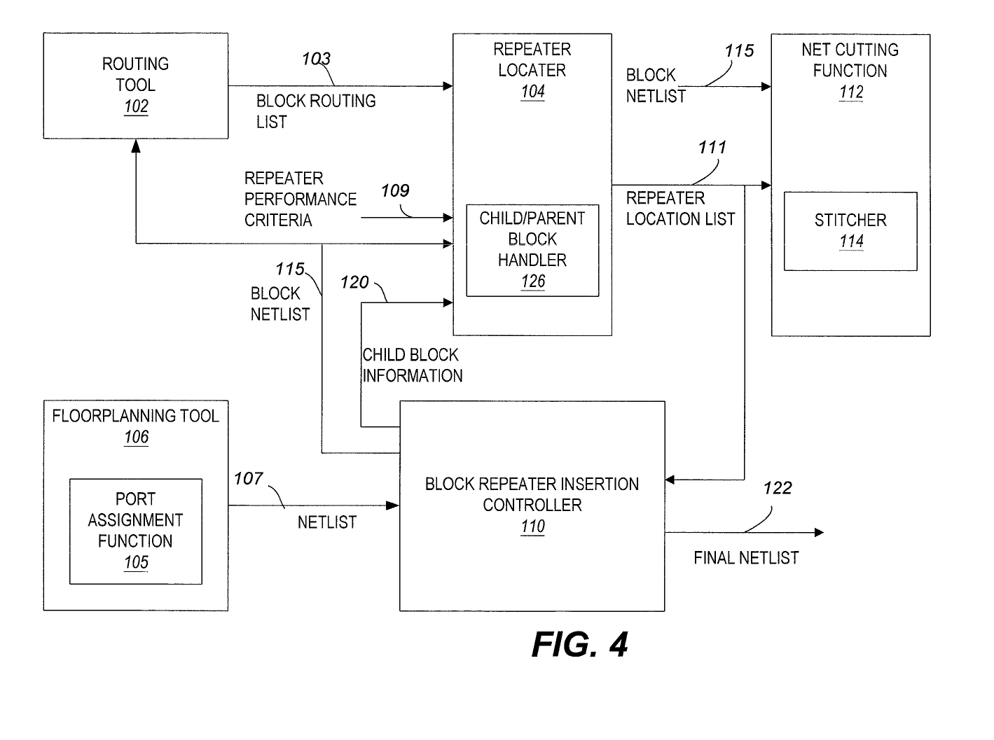

As described in the background section, repeaters are used to improve propagation delay and signal transition times, and are necessary in about any large-scale integrated circuit. FIG. 3 is a flowchart illustrating a novel method for inserting repeaters in integrated circuits according to the functional block hierarchy while preserving the predefined hierarchical functional block interfaces. The method applies when the integrated circuit design defines functional blocks in an hierarchical manner. According to the invention, port locations are defined 2 for the functional blocks over at least three levels, but preferably over the entire design. This is typically done using a floorplanning tool (e.g., Synopsys' Chip Architect) with the goal to minimize wire length or better facilitate routing between the ports of the functional blocks.

Once the ports are assigned, blocks in a first unprocessed level (step 4) of the functional block hierarchy are selected 6. The selected blocks are each routed 8 and then repeaters are inserted 10 in the routed blocks. The process repeats recursively for each level in the functional block hierarchy until all levels are processed.

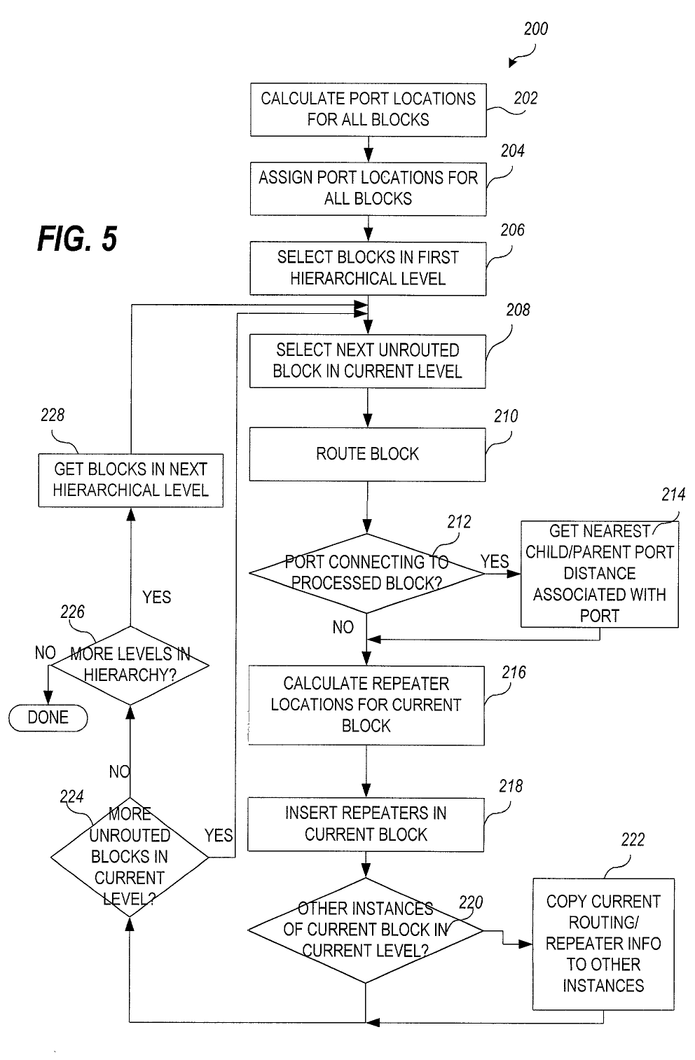

FIG. 4 is a block diagram of an illustrative embodiment of a CAD tool environment 100 in which the method of the invention is implemented. CAD tool environment 100 may comprise a single software package that implements all of the features shown and described with respect to FIG. 4, or alternatively may comprise several software tools that together implement all the features. CAD tool environment 100 includes a routing tool 102, a repeater locator tool 104, a graphical floorplanning tool 106, and a block repeater insertion controller 110. In the illustrative embodiment, routing tool 102 and graphical floorplanning tool 106 are embodied by IC Craftsman, manufactured by Cadence Corp.

Graphical floorplanning tool 106 provides a positional view of the functional blocks defined for a particular integrated circuit. The functional blocks in the integrated circuit are positioned preferably to minimize the length of the wires routed between them. Floorplanning tool 106 includes a port assignment function 105 which is used to assign port locations within the functional blocks, again, preferably to minimize wire length between the functional blocks or to facilitate routing. Once the port locations are assigned, a netlist 107 is generated.

Block repeater insertion controller 110 receives the netlist 107 and feeds block netlists 115 to routing tool 102 on a block-by-block and level-by-level basis until all blocks in each block level are routed.

In particular, routing tool 102 routes the interconnects defined by the block netlist 115 of a functional block within the routing regions, which include channels, feedthroughs, and over-the-block regions, each defined within the functional block being processed. Routing tool 102 generates a block routing list 103 which defines the interconnect nets generated within the block during the routing process.

Repeater locater tool 104 determines a set of repeater locations for each net in the block routing list 103 based on repeater performance criteria 109. Repeater performance criteria 109 may be a predefined maximum wire length X, for example, or may include more complex parameters such as signal transition times, maximum delays, etc. Repeater location tools are known in the art. Preferably, however, the repeater locator tool 104 includes hierarchical repeater location handling 126, as discussed hereinafter with respect to FIGS. 6A through 6C.

Repeater locater tool 104 generates a repeater location list 111 identifying the set of repeater locations for each net in the block. A net cutting function 112, which includes a repeater stitcher 114 stitches a repeater in-place between each net and its assigned repeater location as defined in the repeater location list 111.

Block repeater insertion controller 110 receives the repeater location list and extracts repeater location information 120 including nearest-peer-port and nearest-child-port distances associated with the processed block ports. Block repeater insertion controller then selects another unprocessed block in the same hierarchical level (if any remain), and sends its block netlist to the router tool 102. When all blocks in a given hierarchical functional block level have been processed, block repeater insertion controller 110 selects another unprocessed level (if any remain) and controls the processing of blocks in that level. The block repeater insertion controller 110 continues controlling the processing of functional blocks until all functional blocks in all levels of the functional block hierarchy have been processed. The final netlist 122, including inserted repeaters, is then complete.

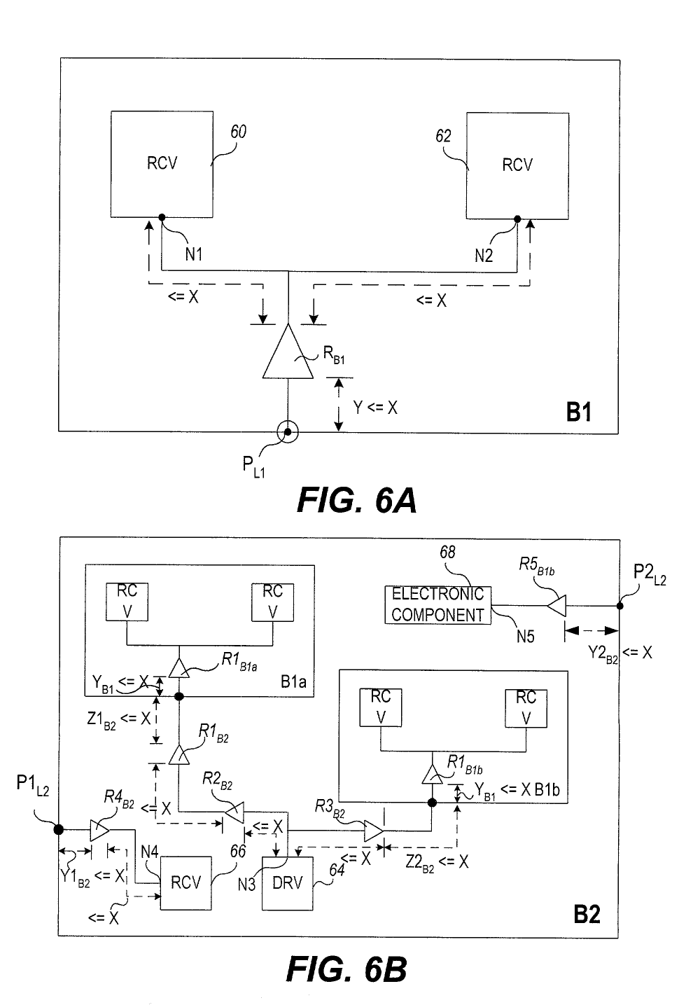

FIG. 5 is a flowchart of a preferred embodiment method 200 of the invention for inserting repeaters implemented in the block repeater insertion controller 110. The method 200 assumes an initial floorplan defining the functional block layout of the integrated circuit, and a netlist. In accordance with the invention, the location of each port in each block is calculated 202 to minimize wire length or to make the routing easiest, and then assigned 204.

A first level in the hierarchy is selected 206. The first level is preferably the bottom level in the hierarchy. A first unrouted block in the selected level is selected 208. The block is then routed 210. If the block includes a port connecting to a previously-processed block (step 212), nearest port distance information is obtained 214. Repeater locations for the current block are calculated 216, taking into account the nearest-port distances from previously-processed functional blocks that is associated with its ports. Repeaters are then inserted 218 at the calculated locations. If other instances of the current block exist (step 220), the current block information is copied 222 to the other instances. If more unrouted blocks in the current level exist (step 224), steps 208 through 224 are repeated. If not, then if more levels in the hierarchy exist (step 226), the blocks in the next level of the hierarchy are obtained 228, and steps 208 through 226 are repeated.

The repeater insertion process of the invention will be better understood from an example implementation illustrated in FIGS. 6A through 6C, based on the functional block hierarchy defined in FIG. 2. As shown, FIG. 6A is a floorplan view of a block B1 at a first level (LEVEL 1) of the functional block hierarchy of FIG. 2. Block B1 includes two receivers 60 and 62 coupled to a port P_{L1}, which are driven from a driver (see FIG. 6B) on another level of the hierarchy. In an example repeater location algorithm, one of the criteria is that no wire length may be greater than X microns in length. In the example shown in FIG. 6A, the distance from receiver ports N1 and N2 and the input port P_{L1} is greater than X microns in length. Accordingly, a repeater R_{B1} is inserted as shown to ensure that the distance between ports N1 and N2 and the repeater R_{B1} is less than or equal to X microns and the distance between the repeater R_{B1} and the input port P_{L1} is also less than or equal to X microns.

FIG. 6B is a floorplan view of a block B2 at the next level (LEVEL 2) in the functional block hierarchy of FIG. 2. Block B2 includes two first level blocks B1a and B1b with input ports P_{L1a} and P_{L1b} each coupled to a driver 64. Blocks B1a and B1b have identical functionality and are routed and implemented identically to block B1 shown in FIG. 6A. Accordingly, all functional circuitry, routing, and repeater locations within the blocks B1a and B1b are identical.

In the preferred embodiment of the invention, the repeater location tool attempts to minimize the number of repeaters across the chip. In order to minimize the number of repeaters, the repeater location algorithm takes into account the distance between each port connecting to a functional block that has already been processed (referred to herein as a “child”) and its nearest repeater or input/output port to an electronic component. When the port connects to a block on a different hierarchical level, the distance is referred to herein as the “nearest-child-port distance”, as is represented herein by the symbol “Y”.

When a block that is being processed includes a port that connects to a child block on a different hierarchical level, it is referred to herein as a “parent block”. A parent block resides on a higher level of the functional block hierarchy than its children. In a parent block, the distance between the port of one of its child blocks and the nearest repeater or input/output port of an electronic component in the parent block is referred to herein as the “nearest-parent-port distance” and is represented herein by the symbol “Z”. When the repeater location tool processes a parent block, it is programmed to ensure that the sum of the nearest-child-port distance Y and the nearest-parent-port distance Z is less than or equal to X microns.

Accordingly, because block B2 includes two child blocks B1a and B1b, each including a port P_{L1a} and P_{L1b} respectively connecting the block B2 with the child blocks B1a and B1b, the repeater insertion algorithm must ensure that the nearest-parent-port distance Z_{B1} in block B2 from each of ports P_{L1a} and P_{L1b} are less than or equal to X microns less the nearest-child-port distance Y_{B1} (i.e., an inserter must be inserted at a distance of Z_{B1} <=X−Y_{B1} from each of ports P_{L1a} and P_{L1b}). Accordingly, as shown, a repeater R1_{B2} is inserted Z1_{B1}<=X−Y_{B1} microns from port P_{L1a}, and a repeater R3_{B2} is inserted Z2_{B1}<=X−Y_{B1} microns from port P_{L1b}.

In the example shown in FIG. 6B, the distance from driver port N3 and repeater R1_{B2} is greater than X microns in length. Accordingly, a repeater R2_{B2} is inserted as shown to ensure that the wire length between the driver port N3 and repeater R1_{B2} is no greater than X microns.

As also shown in FIG. 6B, block B2 includes a receiver 66 which connects to an input port P1_{L2}. In the illustrative example, the distance from receiver port N4 and the input port P1_{L2} is greater than X microns in length. Accordingly, a repeater R4_{B2} is inserted as shown to ensure that the distance is no greater than X microns.

Block B2 also includes an electronic component 68 having a port N5 which connects to a port P2_{L2}. In the illustrative example, the distance from port N5 and the input port P2_{L2} is greater than X microns in length. Accordingly, a repeater R5_{B2} is inserted as shown to ensure that the distance is no greater than X microns.

FIG. 6C is a floorplan view of a block B3 at the next level (LEVEL 3) in the functional block hierarchy of FIG. 2. Block B3 includes three second level blocks B2a, B2b, and B2cwith respective input ports PL2a, PL2b, and PL2ccoupled to respective chip ports P_{L3a}, P_{L3b}, and P_{L3c}. Blocks B2a, B2b, and B2care identical in function, implementation, routing, and repeater placement, each in accordance with block B2 shown in FIG. 6B. Repeater locations are determined in the same manner as described with respect to block B2 in FIG. 6B, where no wire length exceeds X microns, and nearest-parent-port distances Z1_{B2}, Z2_{B2}, and Z3_{B2} associated with ports P1_{L2i a}, P1^{L2b}, and P1_{L2C} do not exceed X−Y1_{B2}, X−Y2_{B2}, and X−Y3_{B2}, respectively.

It will be appreciated from the above detailed description that the invention described herein allows an efficient repeater insertion technique for inserting repeaters in functional blocks of an integrated circuit while preserving the functional block interfaces.

The number of levels in the functional block hierarchy shown in the illustrative embodiment is by way of illustration only and not limitation. Those skilled in the art will understand that the functional block hierarchy in an integrated circuit will typically have many more levels to the hierarchy than those shown in the illustrative embodiment described herein. However, the inventive principles of recursively routing and placing repeaters in blocks on a per-level basis in the hierarchy remains the same regardless of the number of hierarchical levels.

Although the invention has been described in detail in terms of a bottom-up design (i.e., blocks are routed and repeaters inserted on a child-to-parent basis), one skilled in the art will appreciate that the same principles may be equally applied according to a top-down design (wherein blocks are routed and repeaters inserted on a parent-to-child basis).

Although the invention has been described in terms of the illustrative embodiments, it will be appreciated by those skilled in the art that various changes and modifications may be made to the illustrative embodiments without departing from the spirit or scope of the invention. It is intended that the scope of the invention not be limited in any way to the illustrative embodiment shown and described but that the invention be limited only by the claims appended hereto.

What is claimed is:

1. A method for inserting repeaters in an integrated circuit, said integrated circuit implementing a plurality of functional blocks arranged in a plurality of hierarchical functional block levels, said method comprising the steps of:
assigning port locations for said plurality of functional blocks;
selecting an unprocessed hierarchical functional block level;
routing one or more of said plurality of functional blocks that reside in said selected unprocessed hierarchical functional block level to generate one or more routed blocks;
determining whether repeaters are required in said one or more routed blocks; and
inserting repeaters in said one or more routed blocks if said repeaters are determined to be needed; and
repeating said selecting step through said inserting step for another unprocessed hierarchical functional block level.

2. A method in accordance with claim 1, comprising:
repeating said first repeating step until all other unprocessed hierarchical functional block levels have been processed.

3. A method in accordance with claim 1, comprising:
if said one or more routed blocks comprise a parent port connecting to another unprocessed hierarchical functional block level, determining a nearest-child-port distance with said parent port, said nearest-child-port distance indicating a wire length between said parent port and a nearest repeater or electronic component port in said one or more routed blocks.

4. A method in accordance with claim 3, comprising:
if said one or more routed blocks comprise a child port connecting to a processed hierarchical functional block level, determining a nearest-parent-port distance with said child port, said nearest-parent-port distance indicating a wire length between said child port and a nearest repeater or electronic component port in said one or more routed blocks; and
wherein said inserting step inserts repeaters as needed to ensure that a sum of said nearest-parent-port distance and said nearest-child-port distance conforms to repeater location parameters.

5. A method in accordance with claim 1, wherein said routing through inserting steps together comprise:
selecting an unrouted block in said selected unprocessed hierarchical functional block level;
routing said selected unrouted block to generate a routed block;
inserting repeaters in said routed block to generate a processed block if needed; and
repeating said unrouted block selecting step through said routed block repeater inserting step if another unrouted block exists in said selected unprocessed hierarchical functional block level.

6. A method in accordance with claim 5, comprising:
repeating said second repeating step until all other unprocessed blocks in said selected unprocessed hierarchical functional block level have been processed.

7. A method in accordance with claim 6, comprising:
repeating said first repeating step until all other unprocessed hierarchical functional block levels have been processed.

8. A method in accordance with claim 5, wherein said second inserting step comprises:
if said routed block comprises a parent port connecting said routed block to another unprocessed hierarchical functional block level, determining a nearest-child-port distance with said parent port, said nearest-child-port distance indicating a wire length between said parent port and a nearest repeater or electronic component port in said routed block.

9. A method in accordance with claim 8, wherein said second inserting step comprises:
if said routed block comprises a child port connecting to a processed hierarchical functional block level, determining a nearest-parent-port distance with said child port, said nearest-parent-port distance indicating a wire length between said child port and a nearest repeater or electronic component port in said routed block; and
inserting repeaters as needed to ensure that a sum of said nearest-parent-port distance and said nearest-child-port distance conforms to repeater location parameters.

10. A method in accordance with claim 1, comprising:
copying said routed block with repeaters inserted therein to each instance of said selected block in said selected unprocessed hierarchical functional block level.

11. A computer readable storage medium tangibly embodying program instructions implementing a method for inserting repeaters in an integrated circuit, said method comprising the steps of:
receiving a netlist defining port locations for a plurality of functional blocks of said integrated circuit arranged in a plurality of hierarchical functional block levels;
selecting an unprocessed hierarchical functional block level;
causing one or more of said plurality of functional blocks that reside in said selected unprocessed hierarchical functional block level to be routed to generate one or more routed and blocks, and have repeaters inserted in said routed blocks as needed; and
repeating said selecting step through said causing step for another unprocessed hierarchical functional block level of said plurality of hierarchical functional block levels.

12. A computer readable storage medium in accordance with claim 11, the method comprising:
if said one or more routed blocks comprise a parent port connecting to another unprocessed hierarchical functional block level, determining a nearest-child-port distance with said parent port, said nearest-child-port distance indicating a wire length between said parent port and a nearest repeater or electronic component port in said one or more routed blocks.

13. A computer readable storage medium in accordance with claim 12, the method comprising:
if said one or more routed blocks comprise a child port connecting to a processed hierarchical functional block level, determining a nearest-parent-port distance with said child port, said nearest-parent-port distance indicating a wire length between said child port and a nearest repeater or electronic component port in said one or more routed blocks; and
wherein repeaters are inserted as needed to ensure that a sum of said nearest-parent-port distance and said nearest-child-port distance conforms to repeater location parameters.

14. A computer readable storage medium in accordance with claim 11, the method comprising:
repeating said selecting step through said causing step until all other unprocessed hierarchical functional block levels have been processed.

15. A computer readable storage medium in accordance with claim 11, the method comprising:
wherein said causing step causes all of said plurality of functional blocks that reside in said selected unprocessed hierarchical functional block level to be routed and have repeaters inserted in said routed blocks as needed.

16. A computer readable storage medium in accordance with claim 14, the method comprising:
wherein said causing step causes all of said plurality of functional blocks that reside in said selected unprocessed hierarchical functional block level to be routed and have repeaters inserted in said routed blocks as needed.

17. A method in accordance with claim 16, comprising:
copying each routed block with repeaters inserted therein to each instance of said selected block in said selected unprocessed hierarchical functional block level.

18. A system for inserting repeaters along interconnects in an integrated circuit, comprising:
a router which receives a block netlist and generates a block routing list;
a repeater locator which receives said block routing list and generates a repeater location list;
a repeater stitcher which receives said block netlist and said repeater location list and inserts, repeaters into said block netlist as specified in said repeater location list; and
a repeater insertion controller which receives a netlist comprising port assignments for a pluarlity of functional blocks arranged in a plurality of hierarchical functional block levels, and feeds said router with a block netlist corresponding to one or more of said plurality of functional blocks in a first hierarchical functional block level, and, when said router is completed routing said block netlist corresponding to said one or more of said plurality of functional blocks in said first hierarchical functional level, feeds said router with a block netlist corresponding to one or more of said plurality of functional blocks in a next hierarchical functional block level.

19. A system in accordance with claim 18, wherein:
said repeater insertion controller feeds said router with a block netlist corresponding to one or more of said plurality of functional blocks in each subsequent next hierarchical functional block level until all hierarchical functional block levels have been routed.

20. A system in accordance with claim 18, wherein:
said repeater insertion controller receives said repeater location list generated by said repeater locator and calculates a nearest-child-port distance for each port in said routed block associated with said repeater location list that connects to an unprocessed hierarchical functional block level, said nearest-child-port distance indicating a wire length between said associated port and a nearest repeater or electronic component port in said routed block associated with said repeater location list; and
said repeater locator comprises a child/parent block handling function which receives said nearest-child-port distances, and when processing a routed block that comprises a port connecting said routed block to a routed block on a processed hierarchical functional block level, determining and associating a nearest-parent-port distance with said port, said nearest-parent-port distance indicating a wire length between said parent port and a nearest repeater or electronic component port in said functional block being processed, and locates repeaters as needed to ensure that a sum of said nearest-parent-port distance and said nearest-child-port distance conforms to repeater location parameters.
